(19) United States
(12) Patent Application Publication
(10) Pub. No.: US 2025/0153393 A1
(43) Pub. Date: May 15, 2025

(54) SYSTEM AND PROCESS FOR INTRODUCING A LANCE INTO A CONCRETE MIXING TRUCK

(71) Applicant: Airgas, Inc., Radnor, PA (US)

(72) Inventor: Stephen BILGER, Twinsburg, OH (US)

(21) Appl. No.: 18/389,399

(22) Filed: Nov. 14, 2023

(51) Int. Cl. B28C 5/46; B28C 5/02; B28C 5/06

(52) U.S. Cl. CPC B28C 5/468; B28C 5/026; B28C 5/06

(57) ABSTRACT

An apparatus for cooling a concrete mixture, including a mobile base, and an arm support assembly. The arm support assembly is pivotally attached to the mobile base, and wherein the arm support assembly is configured to fold against the mobile base for transport. An arm assembly, wherein the arm assembly is configured to move along the arm support assembly, and wherein the arm assembly is configured to fold against the arm support assembly for transport. A lance assembly, wherein the lance assembly is configured to be inserted into a cement mixer, wherein the lance assembly is configured to fold against the arm assembly for transport. A method for cooling a concrete mixture, including positioning the lance and cement truck to enter the opening of a cement truck. Inserting the lance into the cement truck and introducing liquid nitrogen into the concrete mixer and thereby mixing with the cement mixture.

### BACKGROUND

In concrete preparation it is often necessary to cool the concrete mix. The structural integrity of concrete is dependent on the temperature at which the concrete is set. In general, the cooler the concrete when poured, the stronger it will be once set. If poured at high temperatures, set concrete will often not meet minimum strength requirements. This is especially true in warm weather climates (e.g., pours done in the summer).

Traditionally, this problem was overcome by cooling the water used in mixing the concrete or by adding ice as a partial replacement for the water. The water was cooled using a refrigeration unit, ice, or a cryogenic liquid which was mixed with the water before mixing the concrete. These methods are costly, time consuming and labor intensive. The extensive equipment and labor required for conventional approaches pose various safety concerns such as back injuries from lifting ice, loss of limbs from operating ice crushers, etc. Further, the use of ice can have a negative impact on the concrete's characteristics, such as the slump measurement.

Another approach is to inject a cryogenic liquid directly into a concrete mixer drum of a truck while it is being mixed in a conventional rotating mixer. However, the injection processes used previously were cumbersome and expensive. Prior injection systems were stationary injectors, which required time-consuming structural adjustments in order meet the requirements of different size mixers. Further, the current injection systems are designed in a manner that increases the potential damage to the truck mixer drum.

Therefore, there is a need for an efficient and economically feasible apparatus and method for cooling concrete.

### SUMMARY

An apparatus for cooling a concrete mixture, including a mobile base, and an arm support assembly. Wherein the arm support assembly is pivotally attached to the mobile base, and wherein the arm support assembly is configured to fold against the mobile base for transport. An arm assembly, wherein the arm assembly is configured to move along the arm support assembly, and wherein the arm assembly is configured to fold against the arm support assembly for transport. A lance assembly, wherein the lance assembly is configured to be inserted into a cement mixer, wherein the lance assembly is configured to move along the arm assembly, and wherein the lance assembly is configured to fold against the arm assembly for transport.

A method for cooling a concrete mixture, including providing an apparatus as described above. Adjusting the apparatus so that the lance is positioned to enter the opening of a cement truck. Positioning the cement truck, having disposed therein a cement mixture that is to be mixed and poured, proximate to the apparatus. Wherein the apparatus is independent of the cement truck. Inserting the lance into the opening of the cement truck and introducing liquid nitrogen into the concrete mixer and thereby mixing with the cement mixture.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1a is a side view of a schematic representation of the basic layout of a trailer that is suitable for use with the present invention.

FIG. 1b is a front view of a schematic representation of the basic layout of a trailer that is suitable for use with the present invention.

FIG. 2a is a front view of a schematic representation of the basic layout of arm support assembly and arm assembly, in accordance with one embodiment of the present invention.

FIG. 2b is a top view of a schematic representation of the basic layout of arm support assembly and arm assembly, in accordance with one embodiment of the present invention.

FIG. 2c is a front view of a schematic representation of one aspect of the basic folding process of arm assemblies, in accordance with one embodiment of the present invention.

FIG. 2d is a top view of a schematic representation of one aspect of the basic folding process of arm assemblies, in accordance with one embodiment of the present invention.

FIG. 2e is a front view of a schematic representation of one aspect of the basic folding process of arm assemblies, in accordance with one embodiment of the present invention.

FIG. 2f is a top view of a schematic representation of one aspect of the basic folding process of arm assemblies, in accordance with one embodiment of the present invention.

FIG. 3a is a side view of a schematic representation of another aspect of the basic folding process of arm assemblies, in accordance with one embodiment of the present invention.

FIG. 3b is a side view of a schematic representation of another aspect of the basic folding process of arm assemblies, in accordance with one embodiment of the present invention.

FIG. 4a is a side view of a schematic representation of one aspect of the lance deployment process, in accordance with one embodiment of the present invention.

FIG. 4b is a side view of a schematic representation of one aspect of the lance deployment process, in accordance with one embodiment of the present invention.

FIG. 4c is a side view of a schematic representation of one aspect of the lance breakaway mechanism, in accordance with one embodiment of the present invention.

FIG. 5a is a front view of a schematic representation of one aspect of the lance deployment process, in accordance with one embodiment of the present invention.

FIG. 5b is a side view of a schematic representation of one aspect of the lance deployment process, in accordance with one embodiment of the present invention.

FIG. 6 is a top view of a schematic representation of the breakaway mechanism, in accordance with one embodiment of the present invention.

FIG. 7a is a side view of a schematic representation of the complete basic deployed system, in accordance with one embodiment of the present invention.

FIG. 7b is a front view of a schematic representation of the complete basic deployed system, in accordance with one embodiment of the present invention.

FIG. 8 is a schematic representation of the complete basic deployed system, in accordance with one embodiment of the present invention.

FIG. 9 is a schematic representation of the complete basic deployed system including a separate pump attached to the mounting bed, in accordance with one embodiment of the present invention.

FIG. 10a is a side view of a schematic representation of another aspect of the basic folding process of arm assemblies, in accordance with one embodiment of the present invention.

FIG. 10b is a side view of a schematic representation of another aspect of the basic folding process of arm assemblies, in accordance with one embodiment of the present invention.

FIG. 10c is a side view of a schematic representation of another aspect of the basic folding process of arm assemblies, in accordance with one embodiment of the present invention.

### ELEMENT NUMBERS

101=mounting bed
102=wheels
103=ground support member
104=arm support base
201=arm support member
202=cross beam member
203=lower arm cross beam member
204=upper arm cross beam member
205=arm vertical support member
206=arm hinging mechanism
207=arm support assembly (comprising 201 and 202)
208=arm assembly (comprising 203, 204, and 205)
208a=left arm assembly
208b=right arm assembly
301=assembly hinging mechanism
401=lance
402=lower guide member
403=upper lifting member
404=lance mast
405=ball joint/breakaway mechanism
406=lance assembly
407=lance assembly actuator
701=diverter valve
702=control cabinet with PLC and battery
703=feed hose
704=return hose
705=fluid line
706=cryogenic pump
801=mobile liquid nitrogen supply

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present system provides an improved apparatus and a process for injecting a cooling fluid into a concrete mixing container. The system comprises one or more lance device(s) that is(are) movably mounted on to a mobile support structure. The lance device includes at least two articulated arms and associated means that act on the articulated arms. With the means that acts on the articulated arms of the lance device, it is possible to control both the angle as well as insertion and retraction movement of the rigid lance with regard to the concrete mixing container. The present system is designed to be mounted to a mobile structure, and may be folded and collapsed, lowered onto the mobile structure, and then transported to the next jobsite.

The present system is designed to be mobile and be mounted directly to a trailer, flat-bed truck, or moveable platform. Rather than be disassembled once the work is complete, the current system may be folded together and lowered so that it is quickly ready for transport to the next job. The folding design also makes setup and commissioning a faster process. No foundation is required as is for the stationary unit, which reduces deployment time and costs. An added advantage is that the mobile system may consist of two or more lances as opposed to one as is known in the art. Having two lances doubles the throughput and increases the reliability of the overall system. If one lance should fail, the second lance can continue to operate.

Details of the design and operation of the lance (401), valve (124), fluid line (122), injection nozzle (112), actuator (407) and electronic controller (118), at least, are all as described in U.S. Pat. No. 8,708,547, the relevant part which is incorporated herein by reference.

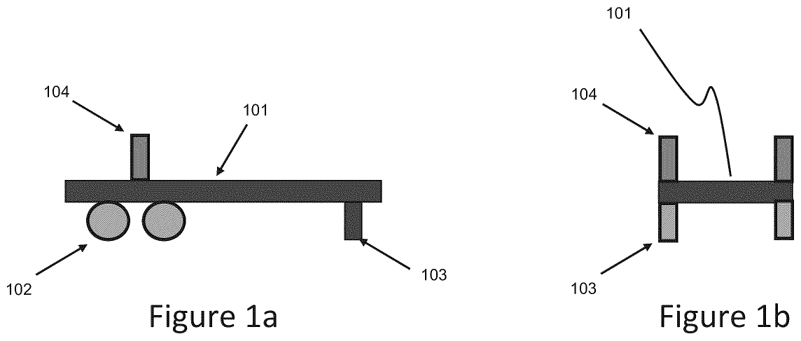

Turning to FIG. 1a (side view) and FIG. 1b (front view), the basic layout of a trailer that is suitable for use with the present invention is provided. In one embodiment, mounting bed 101 may be a mobile platform with or without wheels (not shown). This basic layout includes, at least, mounting bed 101, wheels 102, ground support member 103, and arm support base 104. Ground support member 103, or a functional equivalent, will support the front end of the trailer once detached from the truck, and allow mounting bed 101 to be appropriately leveled. Arm support base 104 will attach to arm assembly 208, as discussed below.

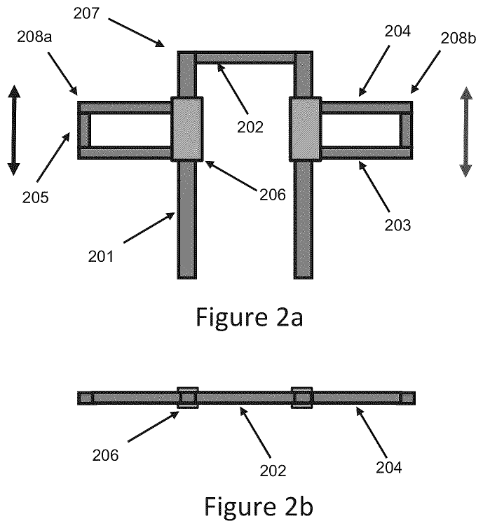

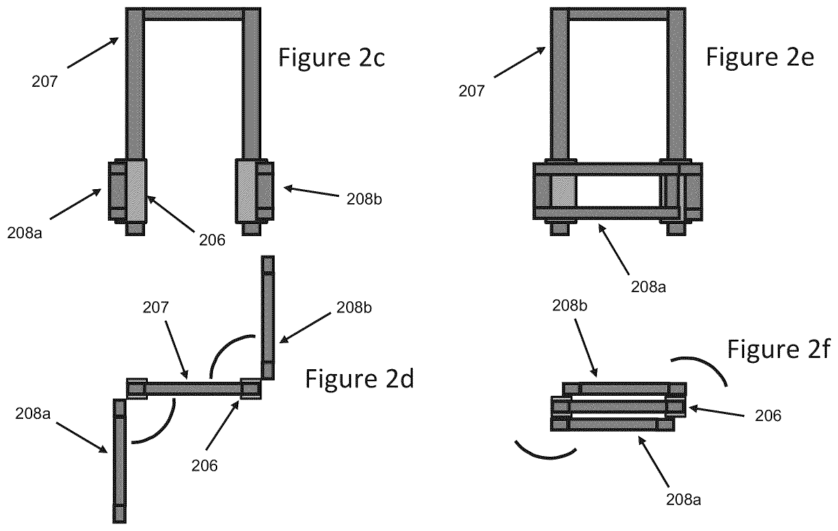

Turning to FIG. 2a (front view) and FIG. 2b (top view), one non-limiting example of the basic layout of arm support assembly 207 and 208, in accordance with one embodiment of the present invention are provided. It will be recognized by one of ordinary skill in the art that other arm designs and configurations are also possible, that will work with the present invention. This basic layout includes, at least, two arm support members 201, crossbeam member 202, lower arm crossbeam member 203, upper arm crossbeam member 204, and arm vertical support member 205.

Collectively, arm support members 201 and crossbeam member 202 form arm support assembly 207. Collectively, lower arm crossbeam member 203, upper arm crossbeam member 204, and arm vertical support member 205 form arm assembly 208. Connecting each arm assembly 208 to arm support assembly 207 are arm hinging mechanisms 206. As will be described below, arm hinging mechanism 206 allows arm assemblies 207 to be moved to different locations along the length of arm support assembly 207. For purposes of clarity, the “left” arm assembly in the figures is designated 208a, and the “right” arm assembly is designated 208b.

Turning to FIG. 2c (front view), FIG. 2d (top view), FIG. 2e (front view), and FIG. 2f (top view), one aspect of the basic folding process of arm assemblies 208, in accordance with one embodiment of the present invention is provided. Beginning in the fully extended position as shown in FIG. 2b. Then, as indicated in FIGS. 2c and 2d, one arm (for convenience, referenced herein as “left arm” assembly 208a) may be folded in the direction of one side of arm support assembly 207, and the other arm (for convenience, referenced herein as the “right arm” assembly 208b) may be folded in the direction of the other side of arm support assembly 207. In one embodiment, arms 208a and 208b are fully “lowered” prior to folding. As used here, the term “lowered” means brought as close as practical to mounting bed 101. Ultimately, as indicated in FIG. 2e and FIG. 2f, both arm assemblies 208a and 208b may lie flat and be pinned or fastened against arm support assembly 207.

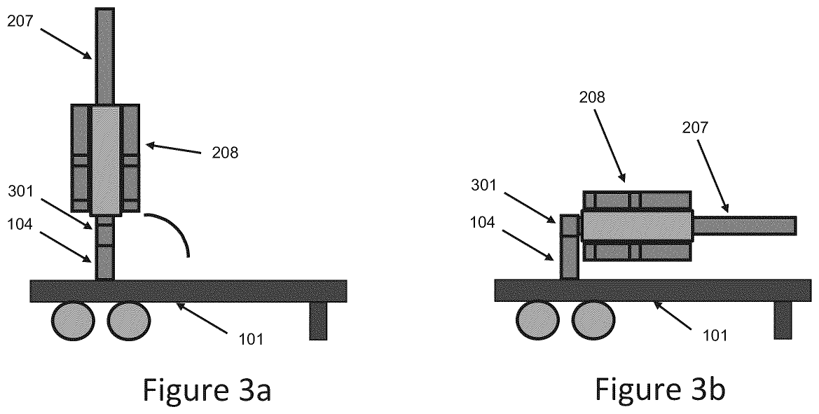

Turning to FIG. 3a (side view) and FIG. 3b (side view), another aspect of the basic folding process of arm assemblies 208, in accordance with one embodiment of the present invention is provided. The erect folded assembly of two arm assemblies 208 and arm support assembly 207 described above is illustrated in FIG. 3a. Assembly hinging mechanism 301 connects arm support base 104 to arm support assembly 207, thereby allowing the two members to rotate relative to one another. As illustrated in FIG. 3b, the arm/support assembly may be folded in the direction of mounting bed 101, thereby positioning the assembly for transport to another location.

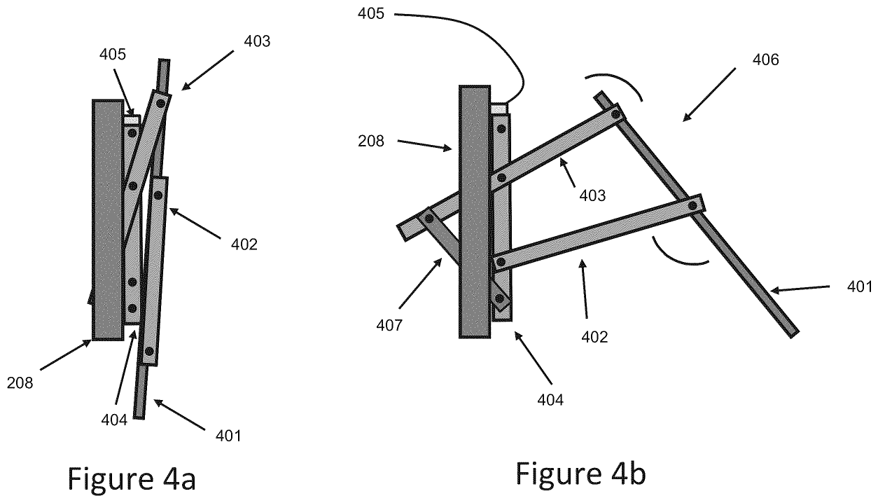

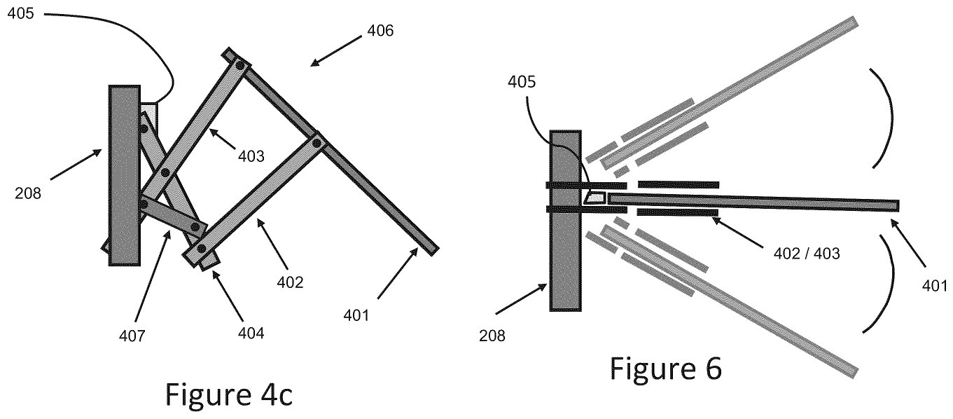

Turning to FIG. 4a (side view) and FIG. 4b (side view), one aspect of the lance deployment process, in accordance with one embodiment of the present invention is provided. The fully folded, undeployed, transport ready mode is shown in FIG. 4a. In this mode, lance 401 is tucked into lower guide member 402 and upper lifting member 403, which are nestled against arm assembly 207.

The deployed mode is shown in FIG. 4b. In this mode, an actuator 407 (now shown) rotates upper lifting member 403 away from arm assembly 208 as shown, pivoting on lance mast 404. Lower guide member 402 and upper lifting member 403 are rotatably attached to lance mast 404, as well as being rotatably attached to lance 401. As upper lifting member 403 rotates down, lance 401 pivots down and outward and into delivery position. Collectively, lance assembly actuator 407, lance 401, lower guide member 402, upper lifting member 403, lance mast 404, and ball joint/breakaway mechanism 405 form lance assembly 406.

Breakaway devices for such a lance are known in the art. However, typical systems function in only one direction (typically more-or-less in line with the center axis of the lance as depicted in FIG. 4c. This allows the concrete mixing truck to pull away with the lance still inserted in the mixing drum. This breakaway helps prevent damage to the unit or drum and reduces the time it takes to get the unit operational again after a pull away event. Ball joint 405 in the present lance design expands on this feature by allowing the breakaway to occur perpendicularly as well as depicted in FIG. 6. Perpendicular collisions can occur when the lance is not centered in the truck's hopper and the drum's baffles strike it as the drum revolves.

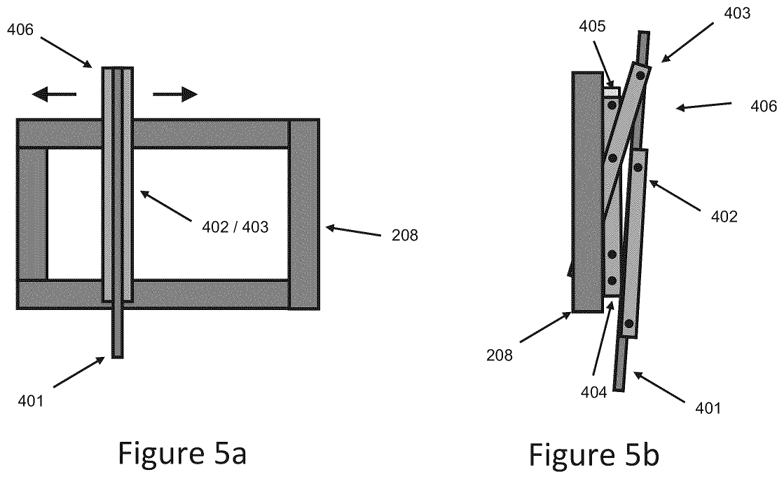

Turning to FIG. 5a (front view) and FIG. 5b (side view), another aspect of the lance deployment process, in accordance with one embodiment of the present invention is provided. While FIG. 5b shows lance assembly 406 undeployed, the movement illustrated in FIG. 5a also applies to lance assembly 406 when deployed. Lance assembly 406 may move laterally, as shown, on arm assembly 208 by means of an actuator (not shown) via track wheels, slide bearings, and/or telescoping cross beams (203 and 204). This, along with the angle of deployment as indicated in FIG. 4b, allows the operator to properly position lance 401 for entry into the cement mixer (not shown).

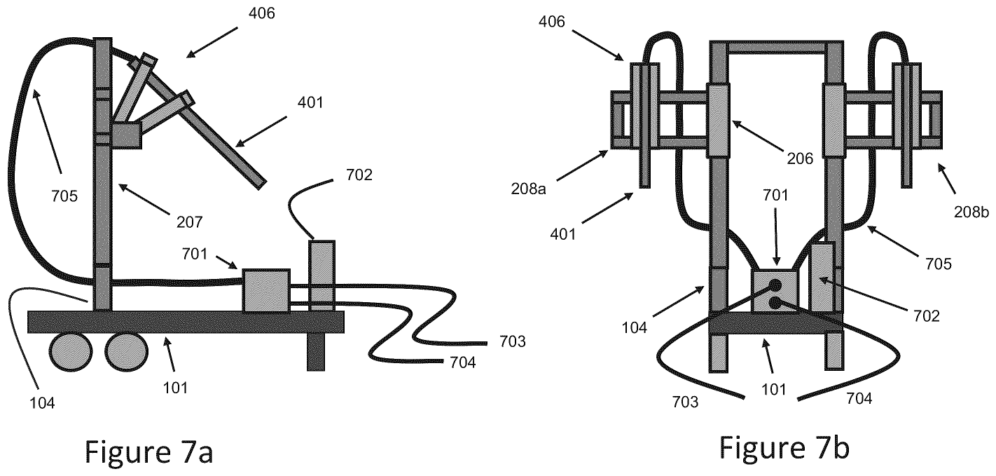

Turning to FIG. 7a (side view) and FIG. 7b (front view), the complete basic deployed system, in accordance with one embodiment of the present invention is provided. Arm support assembly 207 is pivotally attached to arm support base 104 of mounting bed 101. Arm assemblies 208a and 208b are movably attached to arm support assembly 207. Lance assemblies 406 are movably attached to arm assemblies 208. Diverter valve 701, and control cabinet (with PLC and battery) 702 are attached to mounting bed 101. Fluid lines 705 connect diverter valves 701 to lance assemblies 406. Feed hose 703 and return hose 704 attach to diverter valve 701.

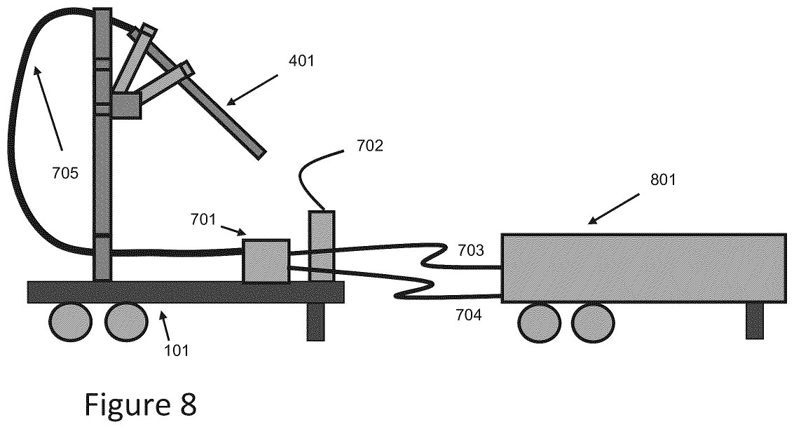

Turning to FIG. 8 (side view), the assembly described in FIG. 7a and FIG. 7b is shown attached to mobile liquid nitrogen supply 801. Feed hose 703 and return hose 704 attach to mobile liquid nitrogen supply 801, thereby providing liquid nitrogen to the injection assembly. Mobile liquid nitrogen supply 801 may be a bulk liquid nitrogen transport truck as is known in the art.

The present system may be configured to operate with powered actuators as controlled by a PLC and an operator pendant, or with a rope-pulley system (not shown) under manual operation. For a manual setup, ropes and pulleys can move the lance mechanism left or right to center the lance to the truck's drum, and additional pulleys can control the insertion and retraction of the lance. Manual valves would control the flow of nitrogen. The manual setup allows the unit to continue operating in case of failure of the electronic components. The present system, when electronically controlled, is powered by one or more batteries, which need infrequent recharging. This increases the reliability of the system and allows the unit to operate during power outages without a generator.

In a typical stationary system as known in the art, liquid nitrogen is supplied from a permanent bulk installation, which requires a significant investment and time to set up. The present system is equipped with a diverter valve which allows a safe, direct connection with a liquid nitrogen (LIN) transport, so no bulk installation is needed. When the unit is electronically controlled, the LIN transport can operate unattended and prevent the deadheading and cavitation of the transport's pump, which can cause premature wear or damage to the pump or valves and stop the flow of nitrogen. Deadheading occurs when the process valve(s) close while the pump is still running. The present system's diverter valve will divert the liquid nitrogen back to the transport via return hose 704 (through its fill connection) in the case the process valves close.

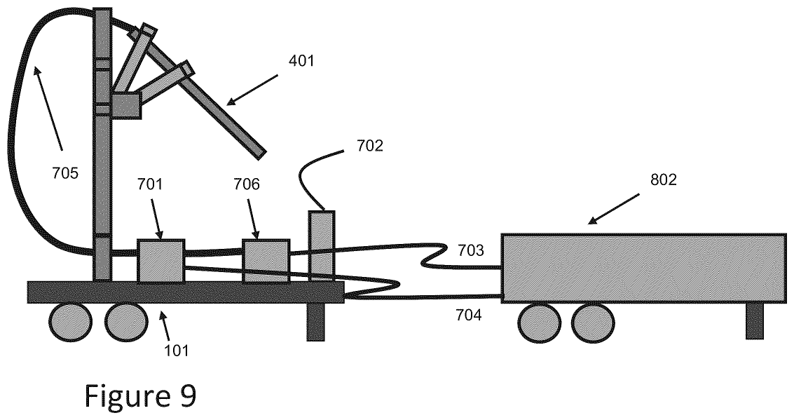

In FIG. 9 the assembly includes a separate pump 706 attached to mounting bed 101 or on its own dedicated skid or trailer to be used with LIN transports or portable tanks not equipped with a pump of their own.

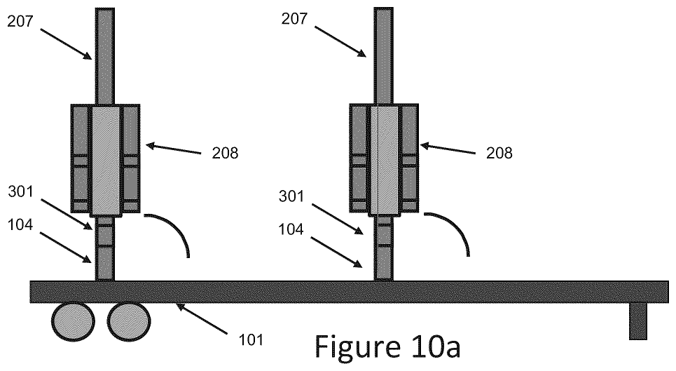

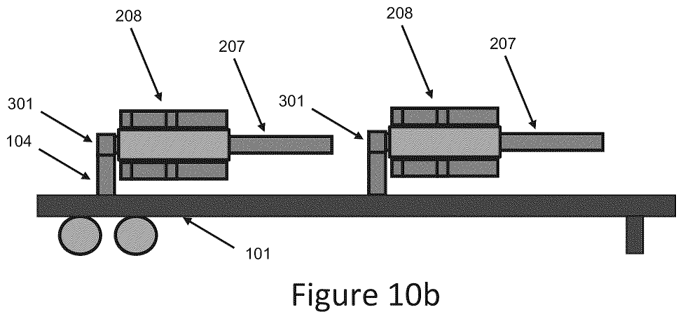

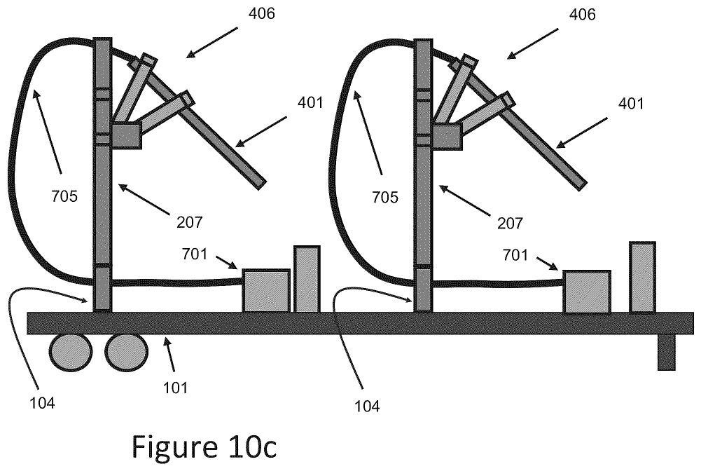

In FIGS. 10a, 10b, and 10c, one non-limiting example of a system having two lances on a single mounting bed 101 is presented. The skilled artisan will recognize that other configurations are also possible.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. An apparatus for cooling a concrete mixture, comprising:
a mobile base,
an arm support assembly,
wherein the arm support assembly is pivotally attached to the mobile base, and
wherein the arm support assembly is configured to fold against the mobile base for transport,
an arm assembly,
wherein the arm assembly is configured to move along the arm support assembly, and
wherein the arm assembly is configured to fold against the arm support assembly for transport,
a lance assembly,
wherein the lance assembly is configured to be inserted into a cement mixer,
wherein the lance assembly is configured to move along the arm assembly, and
wherein the lance assembly is configured to fold against the arm assembly for transport.

2. The apparatus of claim 1, further comprising a breakaway device configured to allow the lance assembly to become disengaged from the arm assembly thereby preventing damage to the apparatus or the cement mixer.

3. The apparatus of claim 1, further comprising a feed hose, a return hose, a diverter valve, and a fluid line,
wherein the feed hose and the return hose are fluidically connected to a liquid nitrogen source and a diverter valve,
wherein the fluid line is fluidically connected to the diverter valve and the lance assembly.

4. The apparatus of claim 3, wherein the liquid nitrogen source is a mobile liquid nitrogen source.

5. The apparatus of claim 1, further comprising a control cabinet.

6. The apparatus of claim 1, further comprising a battery.

7. A method for cooling a concrete mixture, comprising:
providing an apparatus according to claim 1,
adjusting the apparatus so that the lance is positioned to enter the opening of a cement truck,
positioning the cement truck, having disposed therein a cement mixture that is to be mixed and poured, proximate to the apparatus,
wherein the apparatus according to claim 1 is independent of the cement truck,
inserting the lance into the opening of the cement truck, and
introducing liquid nitrogen into the concrete mixer and thereby mixing with the cement mixture.

8. The method of claim 7, wherein the liquid nitrogen is obtained from a liquid nitrogen from a mobile liquid nitrogen source.

9. The method of claim 7, wherein the positioning, inserting, and introducing of liquid nitrogen into the cement mixer are all performed manually.

10. The method of claim 7, wherein the positioning, inserting, and introducing of liquid nitrogen into the cement mixer are all controlled by a control cabinet.

11. The method of claim 9, wherein power required is provided by a battery.

12. The method of claim 10, wherein power required is provided by a battery.

13. The method of claim 7, wherein the lance comprises a breakaway device.

14. The method of claim 7, wherein the lance assembly, the arm assemblies, and the arm support assembly are folded during transport.
